(19) United States
(12) Patent Application Publication
(10) Pub. No.: US 2002/0063018 A1
(43) Pub. Date: May 30, 2002

(54) LUBRICATION SYSTEM

(75) Inventor: JOHN F. SCHIPPERS, ORANGEVILLE (CA)

Correspondence Address: EUGENE J A GIERZAK, KEYSER MASON BALL, 201 CITY CENTRE DRIVE, SUITE 701, MISSISSAUGA, ONTARIO, L5B 2T4, CA

(73) Assignee: KEYSER MASON BALL

(21) Appl. No.: 09/450,120

(22) Filed: Nov. 26, 1999

(51) Int. Cl. F16N 7/16

(52) U.S. Cl. 184/15.1

(57) ABSTRACT

A method of monitoring and controlling the application of a selected amount of lubricant to a plurality of locations comprising placing of plurality of sensors at each of said plurality of locations respectively; placing a plurality of valves in the vicinity of each of said locations for dispensing said lubricant to each of said locations respectively for a selected on position and a selected off position; monitoring and controlling said plurality of sensors and valves by microprocessor means; programming data to said microprocessor means by separable programming means.

### FIELD OF THE INVENTION

This invention relates generally to a method and apparatus for a dispensing system and particularly relates to a method and apparatus for dispensing a selected amount of viscous fluid such as a lubricant at a plurality of locations; and particularly relates to a method and apparatus for separating the controlling and programming functions.

### BACKGROUND ART

Various dispensing systems have heretofore been utilized in the prior art in order to monitor and control the dispensing of desired substances.

For example, U.S. Pat. No. 5,318,197 relates to a method for beverage dispensing control and monitoring. In particular a bottle control cap is attached to a bottle and a microprocessor positioned in the bottle cap is programmed with data to identify the control cap from others in the system of programmable control caps. The, microprocessor controls an electrical motor which opens and closes a flow passage in a control cap on command in response to a signal from a system control processor located at a remote location.

Moreover, U.S. Pat. No. 4,736,871 illustrates that a probe is inserted into a receptor so that contact is made such that the display will display both the volume and the number of times the dispenser has been removed from containers. In addition this patent shows that the probe can be the connection to take information to a separate or central calculator.

Another arrangement is shown in U.S. Pat. No. 5,495,917 which relates to a solenoid air control valve and a plurality of liquid distribution pumps which are mounted on a common elongated manifold having passages for supplying pressurized air and lubricating fluid to the pumps in response to actuation of the solenoid valve. Each of the distributions pumps as an air actuated reciprocating piston and lubricating fluid is supplied to the manifold and distribution pumps through a line connected by supply pump also having an air actuator reciprocating diaphragm or piston.

Yet another arrangement is shown in U.S. Pat. No. 5,509,501 which relates to a device for metered delivery of a liquid or viscous substance to a consumption point.

A further device is illustrated in U.S. Pat. No. 5,813,496 which shows a system for controlling and monitoring of a circulation lubrication of the bearings of the revolving cylinders and rolls in a paper machine in which system a lubricant is fed from an oil lubrication center through a system of pipes into lubrication points associated with the bearings, from which the lubricant is passed back through a system of return pipes into the oil-lubrication center.

Further devices are shown in U.S. Pat. No. 5,878,842 which relates to a volumetric lubricant dispensing apparatus for delivering a precise volume of lubricant such as oil to a rotating machine element. The delivery mechanism includes a piston and cylinder assembly. A plurality of sensors are utilized to control operating conditions of the machine, element environment and lubricant. The apparatus is controlled either manually or with the aid of a controller unit such as a microprocessor. The output from each sensor is inputted into the microprocessor wherein an algorithm computes a responsive output.

Finally U.S. Pat. No. 5,181,585 relates to a lubricating system for supplying several lubricating points more particularly to a lubricant system for a knitting machine.

These and other prior art devices illustrate generally complicated devices. Moreover these and other prior art devices and methods of lubrication generally describe apparatus which when programmed in the field may be tampered with. In other words, apparatus and methods for monitoring and controlling lubricating systems are programmable in the field for selected dispensing of lubricant during an on and off position. However, many of these lubricating systems may be reprogrammed in the field which then leads to lubricating systems which do not work as they are designed to do so.

For example, conveyor systems in automotive assembly plants must be carefully designed to apply a selected volume of lubricant to a location on the conveyor belt so as to prolong the life of the conveyor belt. However, if too much lubricant is applied such conveyor belt tends to drip lubricant thereby fouling the working environment or such lubricant may drip unto the assembled parts of an automobile which can lead to down time for cleaning and the like.

Accordingly there is a need for a lubricating method and apparatus to prevent unwanted programming of the system except by authorized personnel.

It is an object of this invention to provide improved apparatus and method for lubricating systems.

### DISCLOSURE OF INVENTION

It is an aspect of this invention to provide a method of monitoring and controlling the application of a selected amount of lubricant to a plurality of locations comprising placing of plurality of sensors at each of said plurality of locations respectively; placing a plurality of valves in the vicinity of each of said locations for dispensing said lubricant to each of said locations respectively for a selected on position and a selected off position; monitoring and controlling said plurality of sensors and valves by microprocessor means; programming data to said microprocessor means by separable programming means.

It is a further aspect of this invention to provide apparatus for monitoring and controlling the application of a viscous fluid comprising dispensing means; microprocessor means containing data for activating said dispensing means; means for programming said data to, said microprocessor means, said programming means separable from said microprocessor means.

It is yet another aspect of this invention to provide an apparatus for monitoring and controlling the application of a selected amount of lubricant to at least one location comprising at least one sensor disposed at said one location; dispensing means including at least one valve at said one location for dispensing said lubricant to said location in an on position and stopping the dispensing of said lubricant in an off position; microprocessor means containing data for monitoring said sensor means and activating said valve means in response to said sensor means; a means for programming said data to said microprocessor means, said programming means separable from said microprocessor means.

These and other objects and features of the invention shall now be described in relation to the following drawings.

### BRIEF DESCRIPTION OF DRAWINGS

FIG. 1 is a schematic view of the invention.

FIGS. 2a and 2b is a schematic view of the microprocessor means

FIGS. 3a and 3b is a view of the apparatus to lubricate a chain

FIG. 4 is a top plan view of the programming buttons

FIG. 5 is a top view of the programming means and particularly the programming buttons and display.

### BEST MODE FOR CARRYING OUT THE INVENTION

In the description which follows, like parts are marked throughout the specification and the drawings with the same respective reference numerals. The drawings are not necessarily to scale and in some instances proportions may have been exaggerated in order to more clearly depict certain features of the invention.

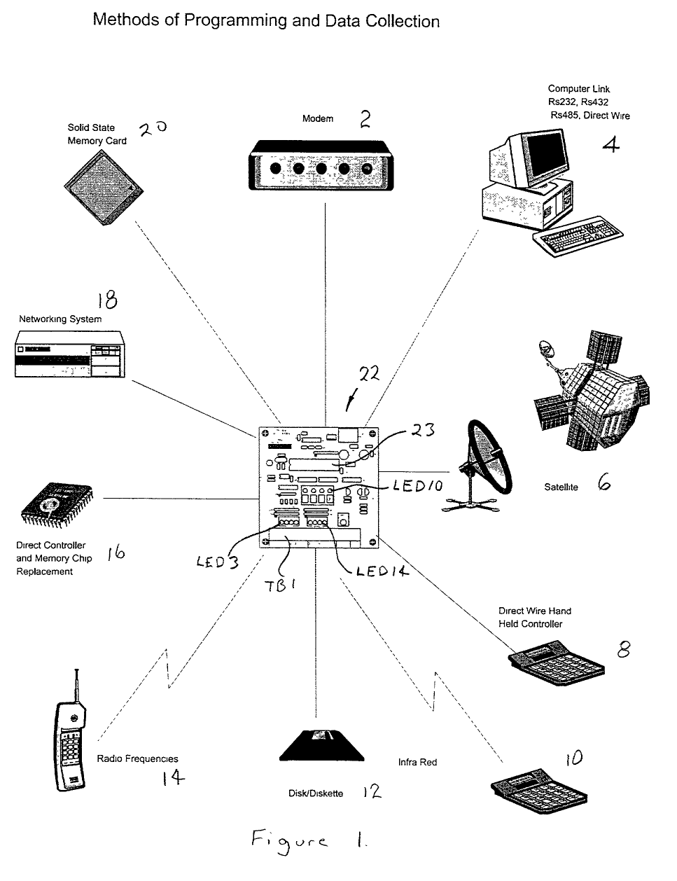

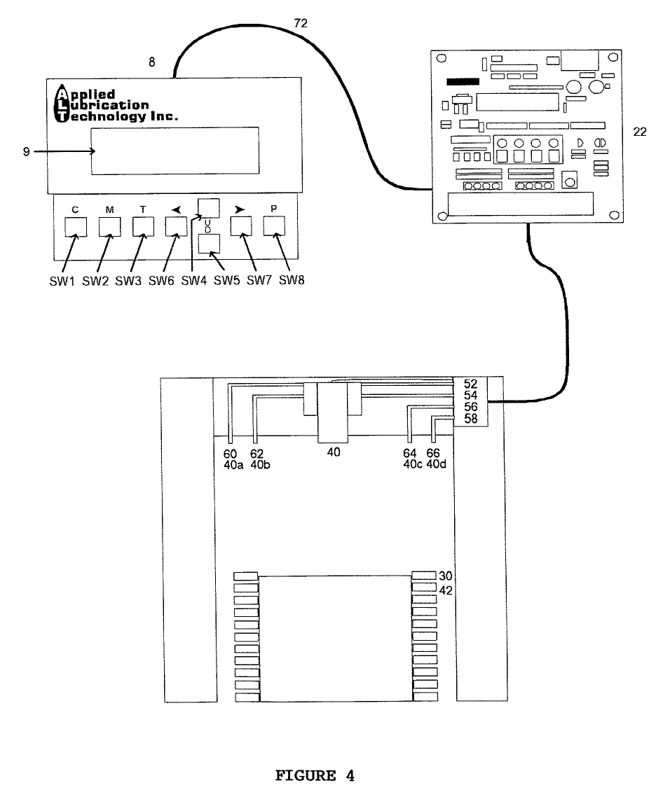

The apparatus and method of monitoring and controlling is generally illustrated in FIG. 1. In particular, FIG. 1 illustrates the separation of the programming means which may comprise a modem 2 or computer link by use of a Rs232, Rs432, Rs485, direct wire 4 or by means of satellite 6 by direct hand wire hand held controller 8 or by infrared means 10, a diskette 12 or radio frequency 14 or direct controller and memory chip replacement 16 or a networking system 18 and finally by solid state memory card 20. In particular the invention shall be described in relation to the direct wire hand held controller or programmer 8. In either of the circumstances the controller or microprocessor 22 is shown for example in a lubricating system as illustrated in FIG. 4.

FIG. 4 illustrates one application of the method and apparatus for monitoring and controlling a lubricating system in an environment including an endless chain 30 in a conveyor system. A sensor 40 such as for example a photo sensor may be utilized in order to count either the number of links 42 or a selected position on the chain 30.

A microprocessor 22 is located in the vicinity of the endless chain 30 and communicates with the sensor. The microprocessor means 22 also communicates with valves 52, 54, 56 and 58 to open and close passageways 60, 62, 64 and 66 which communicate with the dispenser (not shown) so as to dispense a viscous fluid such as oil onto the links 42 of the endless chain 30. The programmable means 8 are illustrated in FIG. 4 and include a cable 72 which is attached to the programmable means 8 at one end thereof and are connectable and separable from the microprocessor means 22 in a manner to be more fully described herein.

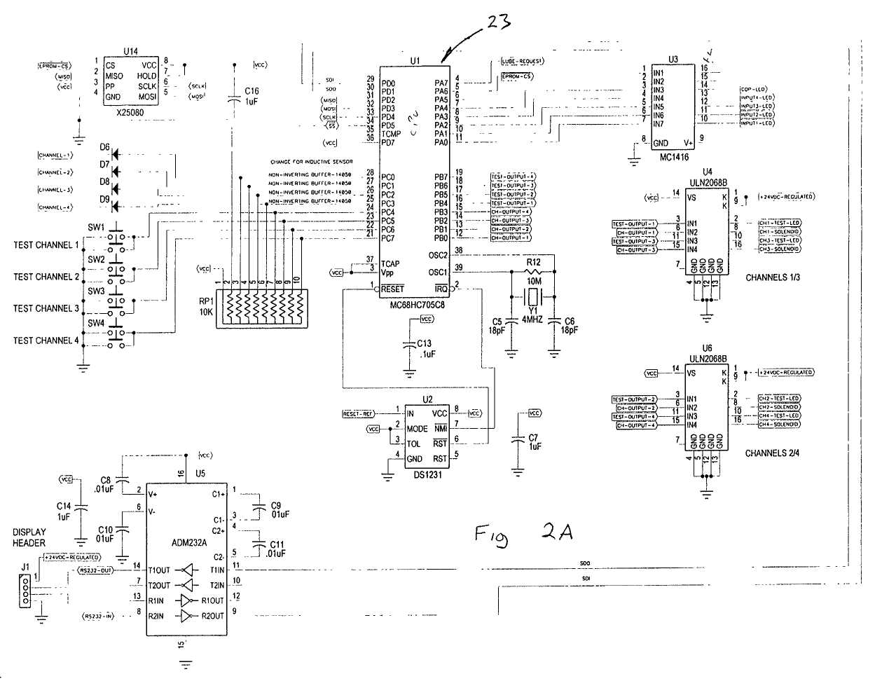

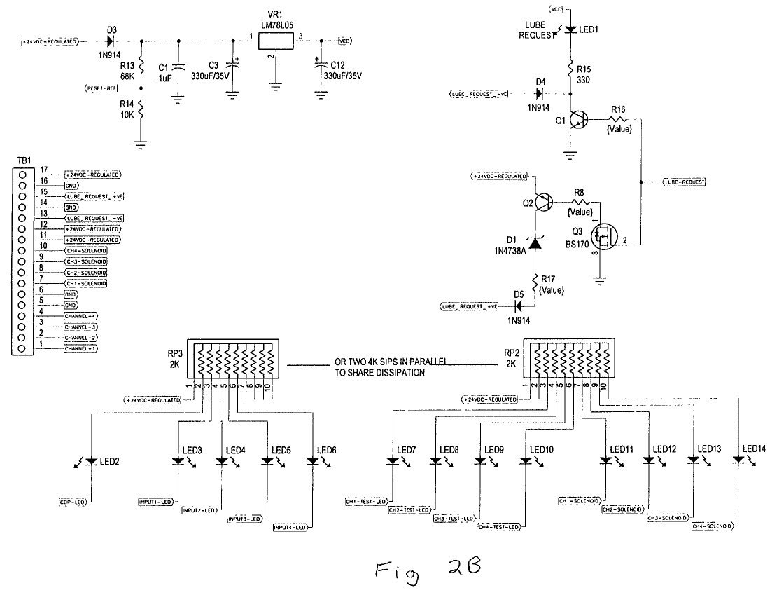

More particularly the microprocessor means controller 22 is generally illustrated in FIGS. 2a and 2b.

In particular the controller or microprocessing means 22 includes connecting bar TB1 having 17 positions. Positions 1, 2, 3 and 4 as shown in FIG. 2b relate to four channels, namely, channel -1, channel -2, channel -3 and channel -4 which can comprise of inputs 1, 2, 3 and 4 which in the example shown in FIG. 4 may comprise up to four separate sensors 40a, 40b, 40c, and 40d. In other words the embodiment shown in FIG. 2b can accommodate up to four different sensors 40a, 40b, 40c and 40d located at four different locations.

Furthermore the connecting bar TB1 as shown in FIG. 2b includes posts 4, 5 and 6 which are grounded. Furthermore connecting posts 7, 8, 9 and 10 of TB1 of FIG. 2b illustrate four outputs on channels CH1, CH2, CH3, and CH4 which may be outputs connected to solenoids 52, 54, 56 and 58 as shown in FIG. 4. Accordingly the microprocessing means 22 may monitor inputs on channel -1, channel -2, channel -3, and channel -4, connected to sensors 40a, 40b, 40c and 40d so as to control outputs on CH1, CH2, CH3 and CH4, so as to control solenoids 52, 54, 56 and 58. Furthermore connecting bar TB1 may be connected to a system whereby a lube request can be monitored and controlled by a negative current by post 13 or by a positive current by post 15. In other words, a lube request may be made to turn on or off a dispenser or lubricating tank. Furthermore appropriate ground wires at posts 14 and 16 are provided while the system is regulated by a 24 volt direct current as shown in post 17.

FIG. 2b also illustrates liquid emitting diodes or light signals LED2 to LED14 inclusive.

In particular LED2 indicates that the system is on, while LED3, LED4, LED5, and LED6, provide light signals to display inputs 1, 2, 3, and 4. Furthermore as shown in FIG. 2b, LED2 to LED6 inclusive are activated by RP3.

Moreover RP2 is connected to light emitting diodes LED7 to LED14. LED7, LED8, LED9, and LED10 can be utilized to test the system and to ensure that CH1, CH2, CH3 and CH4, are working properly. Moreover LED11, LED12, LED13 and LED14 provide means to visually illustrate the activation of solenoids 52, 54, 56 and 58 on CH1, CH2, CH3 and CH4 respectively.

FIG. 2b also illustrates the circuitry for a lube request based on a positive request as well as a negative lube request as described earlier.

Moreover, FIG. 2a illustrates the circuitry as well as the CPU microprocessor 23.

Test buttons SW1, SW2, SW3, SW4 are illustrated so as to test channels 1, 2, 3 and 4 while sensor inputs are shown at the left hand side of page 2a comprising channel -1, channel -2, channel -3, and channel -4 which communicate with the microprocessor 23 at pins 25, 26, 27 and 28. Furthermore the microprocessor 23 controls channel outputs to the solenoids 52, 54, 56 and 58 at pins 12, 13, 14 and 15. Pins 16, 17, 18 and 19 on microprocessor 23 test the outputs on 1, 2, 3 and 4.

One can see from FIG. 2a that U3 activates LED inputs 1, 2, 3 and 4 while U4 and U6 communicate with CH1, CH2, CH3, and CH4 with test LED as well as the CH1, CH2, CH3, and CH4 solenoid as illustrated. Furthermore the microprocessor means 22 includes means for connecting programmable means 8. In particular a connector J1 is illustrated in FIG. 2a which includes four posts that communicate with chip ADM232A. Although connector J1 is illustrated other communication ports may be utilized which communicate with telephone wires or other cables or the like. By utilizing such communication ports programmable means 8 may be utilized which are separable from the microprocesor means. In other words, a lubricating system which is to be described herein may be programmed into the microprocessor means and then the programming means removed from the microprocessor means or controller 22 so as prevent unwanted tampering.

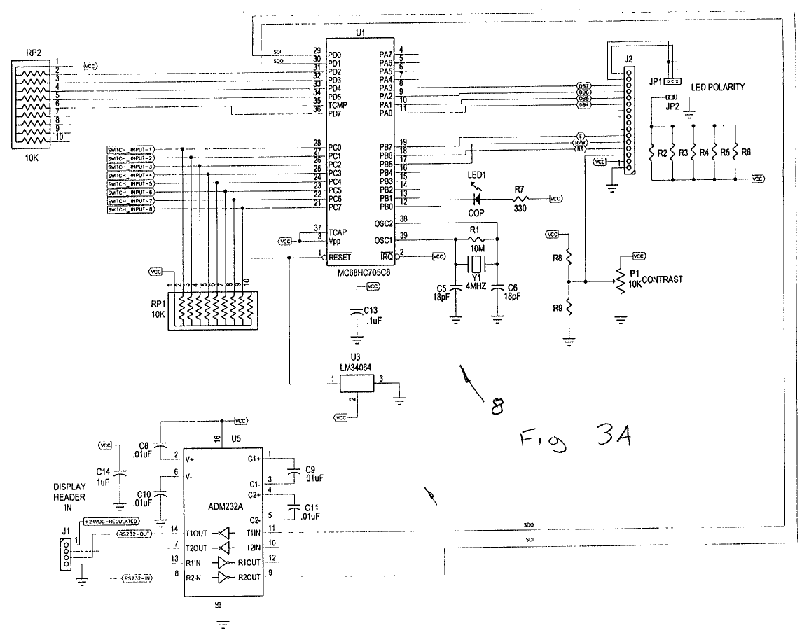

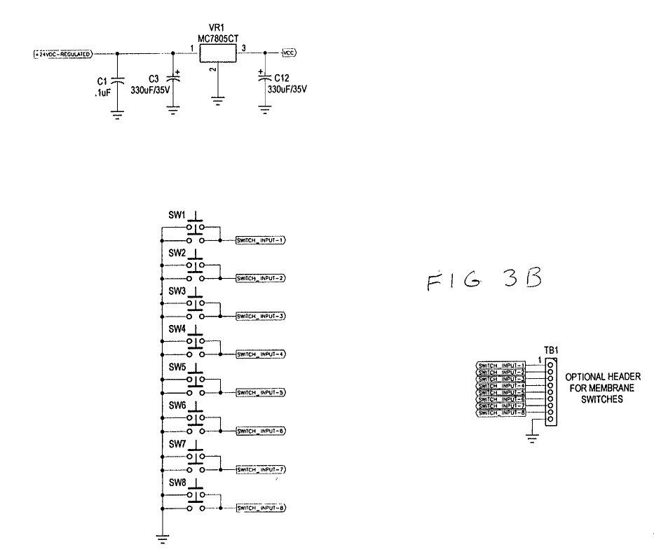

FIGS. 3a and 3b illustrate schematically the programming means 8.

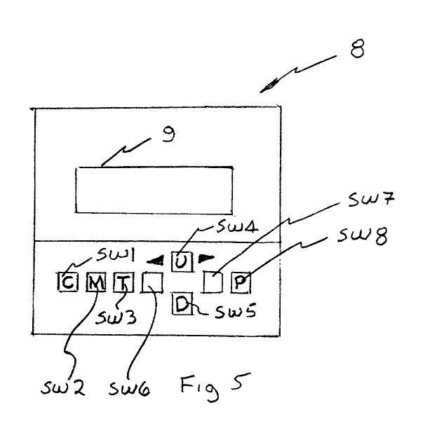

FIG. 5 generally illustrates a hand held programming means 8 having a display 9. FIG. 3b also illustrates an optional header for membrane switches.

In particular FIG. 3b illustrates push button switches SW1, SW2, SW3, SW4, SW5, SW6, SW7, and SW8 which can also be seen in FIG. 5 which are switch inputs 1, 2, 3, 4, 5, 6, 7 and 8 as shown in FIG. 3b.

The circuitry shown at the top of FIG. 3b shows in part the 24 volt regulated direct current.

FIG. 3a also illustrates that chip U1 which is labelled MC6A HC705C8 which permits the programming function and is also connected to the display 9 by means of J2.

In particular switch inputs 1, 2, 3, 4, 5, 6, 7 and 8 as shown in FIGS. 3b and 5 are connected to U1 by means of pins PC0, PC1, PC2, PC3, PC4, PC5, PC6 and PC7.

U1 is connected to U5 which communicates with the microprocessor means 22 by means of J1. Alternative communication ports such as ports permitting communication of telephone wire or the like can be utilized. Accordingly the programmable means 9 may be utilized to program the controller or microprocessor 22 by means of a cable which is connected to J1 as shown in FIG. 3a at one end thereof and connected to J1 of microprocessor means 22 as shown in FIG. 2b. Since the cable is detachable or separable the programmable means 8 may be utilized so as to program the programmable means 22 and thereafter detach from J1 so as to minimize the potential of tampering or changing the settings.

The programming of the programming means shall now be described in connection with FIG. 5.

The display unit 9 can display a number of symbols including:

| | |
|---|---|
| C | Channels 1-4 |
| M | Mode - timer or counter |
| T | Test |
| SW6, SW7 | Scroll through available features |
| U/D | Used to enter values up or down |
| P | Start and end program functioning. |
| CNT | Counter |
| TMR | Timer. |

In order to set up the programmable means 9 one may press C to select channel 1-4. Thereafter one may press P to begin channel program set up by holding the button P for a selected period of time such as for example one second. Thereafter the button M is pressed so as to select the mode which is either Timer mode or Counter mode. In other words one will utilize the programmable means 8 which will at this time be connected to the microprocessor means 22 by means of a cable so as to select the mode of operation of the microprocessor means either to monitor time duration or the counter. In particular one example of utilizing the Counter mode one would program the microprocessor means 22 so that the sensors 40 would count the number of revolutions of a chain 30. The push button M held for a selected period of time such as for example one second. Thereafter the user will proceed with specific instructions for that mode.

For example the Counter mode may be selected or the Timer mode selected as follows:

Counter Mode

The Counter mode will display on display 9 the following:

| | |
|---|---|
| SON | Solenoid On/Expected input calculated in milliseconds (note the |
| | large the number of milliseconds - the larger the shot size of |
| | the lubricant) |
| ONDL | On delay - to phase out false input |
| CON | Number of lubricant ejections desired |
| COFF | Number of off cycles desired. |

By way of an example if a chain 30 is utilized with a thousand links 42 CON could equal 1000 links while COFF could equal 100 (off cycles). These setting will lubricate all 1000 links, then begin a new lubrication cycle after every 100 revolutions. The UD buttons made be pressed so as to increase or decrease the desired count.

For example the display 9 may read as follows:

| | | | |
|---|---|---|---|
| CH1 | SON | 2 | 10 |
| CNT | ONDL | 0 | 0 |
| OPR | CON | 5 | 10 |
| ON | COFF | 1 | 1 |

the above display illustrates an operation channel which is active.

Timer Mode

In the timer mode the following is inputted by utilizing the appropriate push buttons, namely:

| | |
|---|---|
| SON | Solenoid ON - expected input, calculated in milliseconds (note: |
| | the larger the number of milliseconds - the larger the shot size) |
| SOFF | Solenoid OFF - to ensure equal amounts of lubrication |
| | disbursement across the fast moving chain |
| TON | Timer ON - time to remain on |
| TOFF | Timer OFF - time to remain off. |

For example a running chain may take 3 minutes to complete a revolution. In such case the programming means 8 may be utilized so as to program the programmable means 22 so that SON is 10 milliseconds while SOFF is 100 milliseconds with TON being 3 minutes (time to complete a revolution) while TOFF is 10 hours (which is the accumulated running time before the beginning of a new cycle).

Moreover U or T may be pressed so as to go to the next selection either up or down. Furthermore SW6 as SW7 may be pressed to select the value to change and U and D to change the numerical value.

If a button other than SW6 or SW7 or U/D is pressed, no changes will be made and one will be returned to the current channel settings. After all the settings have been selected, P may be pressed and held for one second to end the channel program setup.

The following is an example of the display 9 displaying a signal which is visible during channel setup, namely:

| | | |
|---|---|---|
| CH1 | SON | 00010 |
| ONT | ONDL | 00000 |
| PGM | CON | 00010 |
| ON | COFF | 00001. |

Moreover the following is an example of a test which is made visible during a channel test on the display 9, namely:

| | | | |
|---|---|---|---|
| CH1 | SON | 10 | 10 |
| CNT | ONDL | 0 | 0 |
| TST | CON | 10 | 10 |
| ON | COFF | 0 | 1 |

Accordingly the programming means may be utilized to connect to the microprocessor means so as to program the mode and time duration of the various shots of lubricant to be delivered to a particular location.

The COP-LED light emitting diode LED2 as shown in FIG. 2b will flash when the unit is on and functioning properly. Light emitting diodes LED7, LED8, LED9, and LED10 will be activated or light up during lube requests. Moreover inputs 1, 2, 3 and 4 will light up by means of LED3, LED4, LED5, and LED6 so as to indicate input signals on each of the active channels. The light emitting diodes LED11, LED12, LED13, and LED14 indicate outputs signals on each of the active channels. The test buttons referred to earlier are located directly beneath the channel test indicator lights so as to begin a test cycle. To end the test cycle one presses the test button again and will be returned to the active program. In this way the various functions may be tested.

The apparatus and method described herein is capable of supporting four independent lines, namely, channels 1-4 although a plurality of sensors and channels and outputs may be utilized.

In operation a plurality of sensors are located at desirable locations so as to sense a selected condition such as for example counting the number of revolutions of an endless chain about a particular point. Such sensor in this case may consist of photo sensing means. Moreover a plurality of valves such as solenoid valves may be positioned at particular locations. Such solenoid valves control the on and off positions of a dispenser at particular locations such as utilizing conduits or the like. The solenoids are connected to the programmable means 22 as described above. Furthermore the sensors are also connected to the programmable means 22 as described above. A lubricant may be located in a dispenser or the like. The programming means 8 may be connected to the microprocessor means so as to program the desired time duration or count as described above. Thereafter the microprocessor means monitors the inputs from the sensors and activates the solenoid valves in accordance with a program which is resident as data within the microprocessor 23. The data has been inputted by the programming means 8.

Although the invention has been described in relation to the use of a programming means 8 which is selectively connected and disconnected to the microprocessor means 22 other means of programming the microprocessor means may be utilized as for example shown in FIG. 1.

Various embodiments of the invention have now been described in detail. SInce changes in and/or additions to the above described best mode may be made without departing from the nature, spirit or scope of the invention, the invention is not be limited to said details.

Although the preferred embodiment as well as the operation and use have been specifically described in relation to the drawings, it should be understood that variations in the preferred embodiment could be achieved by a person skilled in the trade without departing from the spirit of the invention as claimed herein.

1. A method of monitoring and controlling the application of a selected amount of lubricant to a plurality of locations comprising:
(a) placing of plurality of sensors at each of said plurality of locations respectively;
(b) placing a plurality of valves in the vicinity of each of said locations for dispensing said lubricant to each of said locations respectively for a selected on position and a selected off position;
(c) monitoring and controlling said plurality of sensors and valves by microprocessor means;
(d) programming data to said microprocessor means by separable programming means.

2. A method as claimed in claim 1 wherein said programming means programs data to said microprocessor means by means of a detachable cable.

3. A method as claimed in claim 1 wherein said programming means programs data to said microprocessor means by infrared means.

4. A method as claimed in claim 1 wherein said programming means programs data to said microprocessor means by means of radio frequency means.

5. Apparatus for monitoring and controlling the application of a viscous fluid comprising:
(a) dispensing means;
(b) microprocessor means containing data for activating said dispensing means;
(c) means for programming said data to said microprocessor means, said programming means separable from said microprocessor means.

6. Apparatus as claimed in claim 5 wherein said dispensing means includes solenoid means for dispensing viscous fluid activated by said microprocessor means.

7. Apparatus as claimed in claim 6 wherein said separable programming means programs said data of said microprocessor to activate said solenoid means based on time.

8. Apparatus as claimed in claim 7 wherein said separable programming means programs said data of said microprocessor to activate said solenoid means to dispense said viscous fluid for a time duration on and to stop the dispensing of said viscous fluid for the time duration off.

9. Apparatus as claimed in claim 6 further including:
(a) sensor means; and
(b) wherein said microprocessor means further monitors said sensors means and activates said dispensing means in response to said sensor means.

10. Apparatus as claimed in claim 9 wherein said dispensing means includes solenoid means for dispensing of said viscous fluid activated by said microprocessor means.

11. Apparatus as claimed in claim 10 wherein said separable programming means programs said data of said microprocessor to activate said solenoid means based on a count.

12. Apparatus as claimed in claim 11 wherein said separable programming means programs said data of said microprocessor means to activate said solenoid means to dispense said viscous fluid for a period when said sensor means has sensed said count and stopped said dispensing of said viscous fluid for a period off.

13. Apparatus for monitoring and controlling the application of a selected amount of lubricant to at least one location comprising:
(a) at least one sensor disposed at said one location;
(b) dispensing means including at least one valve at said one location for dispensing said lubricant to said location in an on position and stopping the dispensing of said lubricant in an off position;
(c) microprocessor means containing data for monitoring said sensor means and activating said valve means in response to said sensor means;
(d) means for programming said data to said microprocessor means, said programming means separable from said microprocessor means.

14. Apparatus as claimed in claim 9 including a plurality of:
(a) sensors means disposed at a plurality of locations;
(b) valves at each of said locations respectively.

15. Apparatus as claimed in claim 14 wherein said separable programming means programs said data to said microprocessor means to permit selection of controlling of each said plurality of valves to dispense said lubricant based on time duration or counter.

16. Apparatus as claimed in claim 9 including a conveyor belt and said sensor counts the revolutions of said conveyor belt past said location.

17. Apparatus as claimed in claim 16 wherein said valve comprises a solenoid valve.

18. Apparatus as claimed in claim 17 wherein said separable programming means includes a visual screen.

19. Apparatus as claimed in claim 15 wherein said microprocessor means monitors four sensors and controls four valves.

20. Apparatus as claimed in claim 19 wherein said microprocessor means include test means.
